(19) United States
(12) Patent Application Publication
(10) Pub. No.: US 2008/0268920 A1
(43) Pub. Date: Oct. 30, 2008

(54) Turbulence sensitive mobile device power control

(75) Inventors: Kristopher C. Billmaier, Kirkland, WA (US); John M. Kellum, Woodinville, WA (US); James A. Billmaier, Woodinville, WA (US); David P. Billmaier, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 12/080,167

(22) Filed: Mar. 31, 2008

Related U.S. Application Data
(60) Provisional application No. 60/926,033, filed on Apr. 23, 2007.

(51) Int. Cl. H04B 1/38

(52) U.S. Cl. 455/574

(57) ABSTRACT

A mobile communication device may include one or more sensors to detect shaking and/or swinging of the device when the device is in a low-power or power-down mode. The device may include logic to determine if shaking and/or swinging occurred within an interval of time after the device was used, and logic to remove the device from low power or power down mode (and thus initiate a power-up mode) if shaking and/or swinging occurred within the interval of time after the device was used.

### PRIORITY

This application claims priority under 35 USC 119 to USA application No. 60/926,033 filed on Monday, Apr. 23, 2007, which is presently filed.

### TECHNICAL FIELD

The present disclosure relates to power management for and operation of mobile devices.

### BACKGROUND

Power consumption is an important parameter of mobile device operation. Often, a person will be using their mobile device (such as a phone), and for whatever reason will refrain from operating the controls for a period of time. When this happens, the device may go into a low-power mode, which may result in the screen and/or lit controls going dark. This can be inconvenient and annoying, especially in the dark.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of a turbulence-sensitive mobile communication device.

FIG. 2 is an action flow diagram of a process of power management for a mobile device.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

### Mobile Communication Device Including Turbulence Detection and Power Management

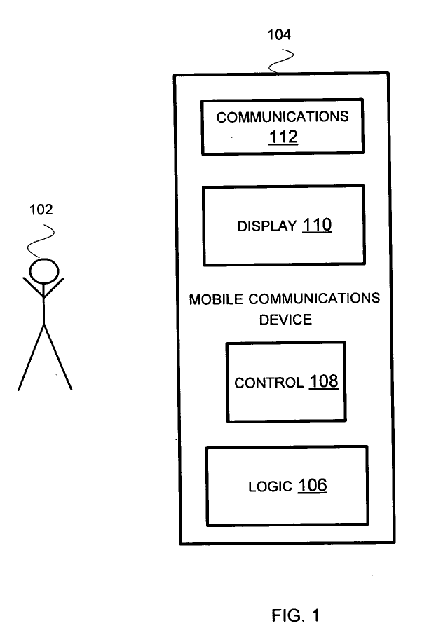

FIG. 1 shows a turbulence-sensitive mobile communication device 104. The mobile communications device 104 may comprise logic 106, a control 108, a display 110, and a wireless communications ability 112. Other elements and/or couplings among the elements have been omitted as they would be apparent to skilled practitioners in the relevant art(s).

A person 102 may be holding or carrying the mobile communications device 104. The mobile communications device 104 may be a portable communication device having long-range wireless communication capability 112, such as, for example, one or more of a cell phone, satellite phone, GPS enabled device, PDA, laptop, notebook, sub-notebook or tablet computer. The term ‘GPS’, as used herein, refers to ‘global positioning system’. The term ‘PDA’ refers to ‘personal digital assistant’. One or more controls 108 are manipulated by the person to effect device functions. The control(s) 108 may be, for example, one or more of a button, dial, switch, sensor or other means to enter information into the device so that the device logic knows to perform a device function.

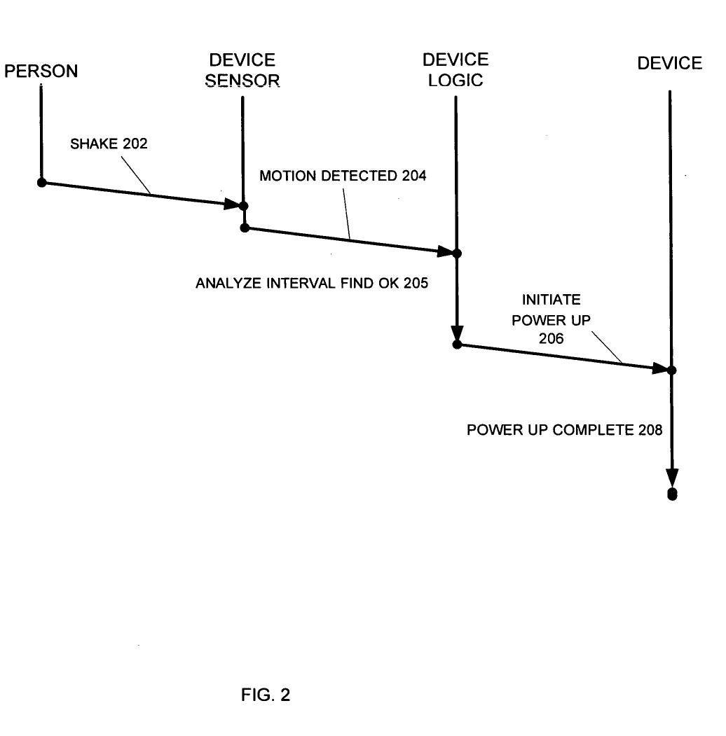

The logic 106 may operate to detect turbulence and manage the power output of the device 104, as further described in conjunction with FIG. 2.

Other examples and/or embodiments of a mobile communications device 104, logic 106, controls 108, display 110, and communications capability 112 may be apparent to skilled practitioners in the relevant art(s).

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

FIG. 2 is an action flow diagram of a process of power management for a mobile device. The device is shaken or otherwise experiences turbulence at 202. At 204 the turbulence is detected and disambiguated from “background” turbulence, such as walking or vehicle motion. At 205 it is determined whether the turbulence occurred within an “activation” interval of some other event indicative of continued use of the device by the user. Such events may include use of a button or other control, or after initiating or receiving a call. If the turbulence occurred within the activation interval, the device is powered up again at 206, which may involve lighting the screen or controls, or otherwise bringing the device into full activation mode. Power up concludes at 208.

### Turbulence Detection for Feature Advance

In some embodiments, turbulence detection may result in the activation or advancement of features and/or functions of a mobile communication device. For example, when a phone call is received, a user of the phone may shake the phone to silence and/or reject the call. As another example, when a phone alarm clock is active, a user of the phone may shake the phone to turn the alarm off.

A user of a phone may wish to scroll through a contact list. The user may shake the phone or invert the phone to scroll down (e.g. the list has some virtual “weight” and by tilting or shaking the phone toward one end of the phone, the list scrolls that direction).

Similarly, when viewing photos on a cell phone, instead of using directional buttons to go to the next or previous photo, a user may shake the phone once in a particular direction, or tilt the phone in that direction, to go to the next or previous photo. For example, the user might shake the phone once toward the right to advance, or shake the phone once toward the left to go to the previous photo.

Similarly to viewing photos, when listening to music on a cell phone, instead of using a directional button to go to the next or previous song on a play list, the user might shake the phone once in a particular direction to go to the next or previous song.

In yet another implementation, when viewing a video on a cell phone, instead of using transport controls (fast-forward, rewind, pause) to control the video display, the user may shake the phone in a particular direction. For example, the user may shake the phone once to the right to fast forward, once to the left to rewind, and once down to pause.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A mobile communication device comprising:
one or more sensors to detect shaking and/or swinging of the device when the device is in a low-power or power-down mode;
logic to determine if shaking and/or swinging occurred within an interval of time after the device was used; and
logic to remove the device from low power or power down mode if shaking and/or swinging occurred within the interval of time after the device was used.

2. The mobile communication device of claim 1, wherein the logic to determine if shaking and/or swinging occurred within an interval of time after the device was used further comprises:
logic to distinguish shaking and/or swinging from typical portable turbulence.

3. The mobile communication device of claim 1, wherein the logic to determine if shaking and/or swinging occurred within an interval of time after the device was used further comprises:
logic to determine if shaking and/or swinging occurred within an interval of time after one or more buttons or other controls of the device were operated.

4. The mobile communication device of claim 1, wherein the logic to remove the device from low power or power down mode if shaking and/or swinging occurred within the interval of time after the device was used further comprises:
logic to light a display, buttons, or other controls of the device if shaking and/or swinging occurred with the interval of time.

5. The mobile communication device of claim 1, wherein the logic to determine if shaking and/or swinging occurred within an interval of time after the device was used further comprises:
logic to cause the device to return to its initial power-up mode as would occur were it turned on by a control such as an on switch or other control when the device is a power-off or low power state.

6. The mobile communication device of claim 1, wherein the logic to determine if shaking and/or swinging occurred within an interval of time after the device was used further comprises:
logic to cause the device to return to a power-up mode which is different from its initial power-up mode as would occur were it turned on by an on switch or other control when the device is in a power-off or low power state.

7. A mobile device comprising:
logic to detect turbulence and to activate or advance a user interface feature in response to the turbulence.

8. The mobile device of claim 7, further comprising:
logic to silence or reject and incoming call.

9. The mobile device of claim 7, further comprising:
logic to silence an alarm.

10. The mobile device of claim 7, further comprising:
logic to scroll through a contact list.

11. The mobile device of claim 7, further comprising:
logic to navigate a photo gallery.

12. The mobile device of claim 7, further comprising:
logic to navigate a play list.

13. The mobile device of claim 7, further comprising:
logic to control pause, play, or control the rate of play of a video.
